(19) United States
(12) Patent Application Publication
(10) Pub. No.: US 2004/0017590 A1
(43) Pub. Date: Jan. 29, 2004

(54) Universal scan to store system and method for using the same

(76) Inventor: Patrick J. Dugas, Winter Haven, FL (US)

Correspondence Address: REED SMITH, LLP, 3110 Fairview Park Drive, Falls Church, VA, 22042, US

(21) Appl. No.: 10/448,079

(22) Filed: May 30, 2003

(51) Int. Cl. H04N 1/04; H04N 1/46

(52) U.S. Cl. 358/474; 358/524

(57) ABSTRACT

A portable, free-standing universal scanner driving device includes a central processing unit, a memory, a slot for receiving an external storage medium, an I/O port, means for writing data on the external storage medium, a case, and one and only one push-button, touch pad, or touch screen for initiating an external optical document scanner to scan a document placed in the scanner and then directly write scanned electronic data into the external storage medium by touching thereon. The push-button, touch pad, or a touch screen is integrally formed on the case.

### BACKGROUND OF THE INVENTION

1. Field of the Invention

The invention generally relates to a single touch “scan to store” system. In particular, the system includes a portable, free-standing universal scanner driving device for a person to scan a document via a scanner directly to a storage media therein from a single interaction with any scanner available in-situ.

2. Description of the Related Art

Document scanners are widely used for both business and home purposes. The optical scanner market continues to explode. Optical scanners differ from one another in terms of scanning technology, resolution, bit depth, size and shape. There are hand-held scanner, sheet-fed scanners, flatbed scanner (like photocopy machines), overhead scanners (like overhead projectors).

An optical scanner reads text or images printed on paper and translate the information into digital data to be stored in a file, displayed on a screen, and manipulated by programs. Most optical scanners do not distinguish text from images (represented as bit maps). Therefore, a computer is required to edit text. To translate the image into ASCII characters, an optical character recognition (OCR) software is required to be installed in the computer. Typically, an analog-to-digital converter in the scanner processes the analog electrical signal to generate a digital representation of this image. Most optical scanners sold today come with OCR packages. Current scanners require a variety of user intervention to carry out the scanning process and effectively store the document on a storage device, such as a disk, a CD or network share.

For example, HP ScanJet II cx is compatible with Macintosh and IBM compatible PCs. For the Macintosh hardware, the scanner can be connected directly to an existing SCSI interface. The recommended requirements for the Macintosh include: 5-8 megabytes of RAM (minimum is 4), 6 megabytes of available disk space for installation of software (DeskScan II and/or Adobe Photoshop), and operation system software version 7.0 or greater (minimum is 6.0.7). For the PC, the scanner requires an adapter card to be installed in the system. The software that does the actual scanning is called DeskScan II (on both Macintosh and PC). The image processing software is Adobe Photoshop for the Macintosh; Aldus PhotoStyler and Image Assistant for the PC. The DeskScan II software does the actual scanning and includes some adjustments. The following are a few of the adjustments that can be made: adjusting the selection area, changing the exposure settings, choosing a new image type, sharpening the image, or scaling the image to the right size. To enhance the images beyond what DeskScan offers requires image processing software such as Adobe Photoshop for the Macintosh, or Aldus PhotoStyler and Image Assistant for the PC.

U.S. Pat. No. 6,166,830 shows an integrated scan-to-store apparatus, having a single housing unit, a flatbed scanner, a CPU, a monitor/screen, commands for controlling or making adjustment on a control panel and a storing means disposed within. It further shows an integrated scan-to-store apparatus that allows images to be scanned and stored on a removable data/storage device. While it eliminates the need for a separate computer, it also eliminates the compatibility with any existing scanners by building a completely new scanner to include a CPU, monitor, scanner and memory storage device as a single unit. In addition, it still requires instructions from operator and certain computer navigation procedures in order to allow choices to include: scanning, manipulating/adjusting and storage. In particular, it requires a high-powered CPU along with extensive RAM and cache memory system, as well as various ports to allow this device to interface with other apparatus. In other words, it compromises existing scanner design in exchange for a “self-contained, integrated configuration” in a stand-alone apparatus including a single housing (having a top surface and an interior space defined beneath said top surface), a high-end CPU processor, some “imagined” miniature monitor, and some sort of abbreviated keyboard.

U.S. patent application Publication No. 2002/0051242 shows an integrated scan-to-store apparatus, having a CPU, a removable storage medium and a control system displaying digital images. It further shows stand-alone flatbed scanner controls for controlling the mode of operation, degree of resolution, related parameters associated with generating, storing and displaying digital data, which requires substantially more input from an operator than U.S. Pat. No. 6,166,830 to control functions, such as: Mode of operation, color or black and white, high-low-medium resolution, LCD display use, erase control, image advance and data compression, in addition to other “operator controlled functions.” It also includes ports for peripherals, an internal hard drive, and software adapted to display images directly on a screen. This patent application shares the same problem as U.S. Pat. No. 6,166,830, and it additionally incorporates a special carriage adapted within the unit with a digital camera positioned on this carriage so as to either conventionally scan a document or take a digital picture of the document. The digital camera picture would also allow viewing on a conventional TV set, and an adapter to couple an auto document feeder.

U.S. Pat. No. 4,943,868 encompasses a compact, lightweight image data filing apparatus with an IC memory card as an image data storing medium, and is primarily designed to be coupled with a hand-held scanner rather than universally compatible with most optical scanners. Image data on an object such as a name card is read by the hand scanner, and filed into the IC memory card. The read data is stored into the IC memory card, together with an ID entered via the keyboard for identifying the image data to be stored. The image data is specified by the ID data entered, and displayed by a liquid crystal display device. As such, it requires additionally a keyboard for entering Ids, and a display for displaying the image data.

Currently, there is a demand for a portable, free-standing universal scanner driving device for an unskilled operator to scan a document directly to a storage media therein from a single interaction with any scanner available in-situ.

### SUMMARY OF THE INVENTION

It is a purpose of this invention to provide a self-contained, portable, and universal compatible scanner driving device for any existing, unmodified scanner to be “plugged” into.

It is another purpose of this invention to eliminate the need for program navigation, a separate PC and a monitor.

It is still another purpose of this invention to provide an easy-to-use, single touch “scan to store” system.

### DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 shows a portable, free-standing universal scanner driving device according to the invention;

FIG. 2 is a block diagram showing one embodiment of the hardware structure of the driving device shown in FIG. 1; and

FIG. 3 is an operation flow chart of the driving device shown in FIG. 1.

### DESCRIPTION OF THE PREFERRED EMBODIMENTS

With reference to the figures, like reference characters will be used to indicate like elements throughout the several embodiments and views thereof.

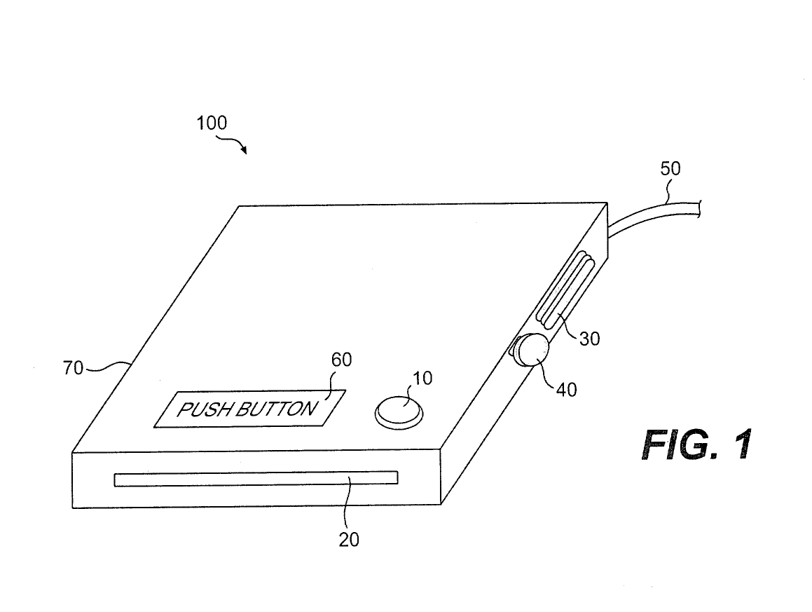

FIG. 1 shows the one-touch scan-to-store device 100 according to the invention to be connected with an external optical scanner, a single input button 10, a slot 20 for receiving a storage medium, such as a floppy disk, a CPU and algorithms for manipulating a scanned image and saving it to the storage medium, a female RS-232 connector 30, a female DIN connector 40, a power cable 50, and a LCD display 60 for displaying textual user information, and a housing case 70.

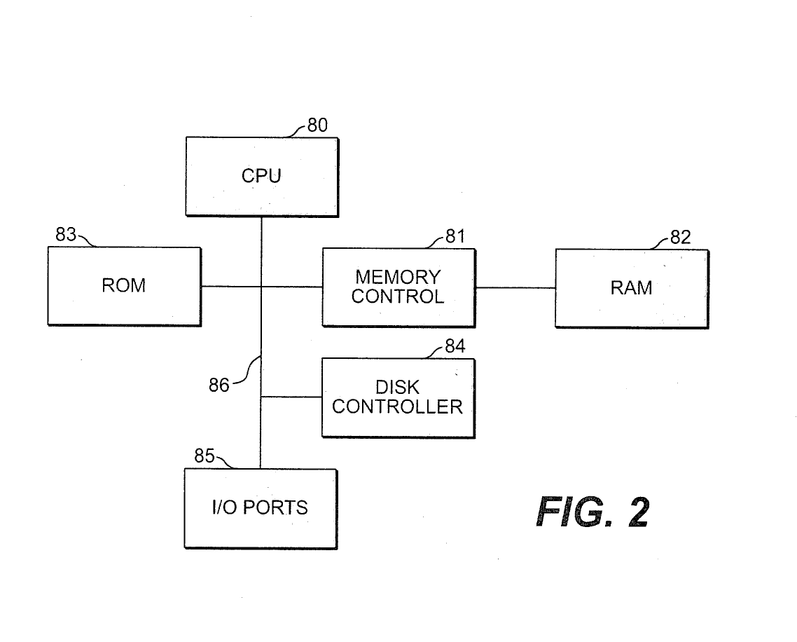

FIG. 2 is a block diagram of the components inside the one-touch scan-to-store device 100, including a CPU 80, a memory control 81, a RAM 82, a ROM 83, a disk controller 84, input/output ports 85 and buses 86 (the data bus, the address and control bus) on a board of 2″×2.5″×0.5″. Because the device 100 incorporates a much slower CPU chip than a computer and much reduced RAM, the size of internal cooling fan is significantly reduced or eliminated altogether. The invention merely includes a very low capacity unit of with sufficient power and memory to drive an existing stand-alone scanner. The speed of the CPU and the size of the RAM are contingent on the scanner and its driving software.

Like other CPUs, the CPU 80 includes a ALU (Arithmetic Logic Unit), internal registers and a CU (control unit) for sequencing the system. The processor has three buses, a bi-directional data bus, mono-directional address bus and control bus. The data bus carries data between various components of the system, typically from memory to the processor or input output controller. The address bus carries an address generated by the processor, which will select one internal register within one of the chips attached to the system and specifies the source or destination of the data which will carry along the data bus. The control bus carries various synchronization signals. The processor needs some sort of clock to synchronize the precise timing references of the system.

The input/output ports 85 include an input parallel port for inputting data from an optical scanner, an output port for outputting date to an storage medium. A standard parallel cable consists of 25-pin that transfer information one byte at a time is used a the parallel port, such as an unidirectional, 4-bit parallel port. Preferably, the output port is a USB port. USB ports are very fast and has two data speeds. 12 Mbps for devices such as scanners, printers, monitors, and modems.

The memory controller 81 controls data reading from and writing to the memory, including the RAM a82 and ROM 83, while the disk controller 84 controls data reading from and writing to the disk.

The power supply via a transformer which converts the 120-volt, 50 Hz, AC current into +5- and +12 v DC current, and +3.3 v as well on some systems. Usually, the digital electronic components and circuits in the system (motherboard, adapter cards, and disk drive logic boards) use the 3.3 v or +5 v power, and the motors (disk drive motors and any fans) use the +12 v power.

To simplify the device and its function, the device does not include any co-processor, sound cards, graphic cards, or E-IDE interfaces.

This software accepts input from the user and facilitates scanning and storage of the document.

Instead of a floppy disk, the disk controller and slot may accommodate a Hard Disk, an Optical Disk, a tape, a CD, a Worm, a Erasable, a Zip disk, a DVD, a flash Memory Card, a Super Disk, or a combination of two or more of these storage media. Alternatively, any such storage medium may be controlled via an external driver.

The ROM and the RAM may be substituted by a Programmable Read-Only Memory (PROM), an Erasable Programmable Read-Only Memory (EPROM), a Magnetic Disk, a Magnetic Tape, a Magnetic Drum, a Magnetic Disc, which increase the performance of the device at the price of size and cost.

The operating system can be one of: Proprietary Software, Windows 2000, Windows 2000 Professional, Windows 2000 Server, Windows Server 2003, Windows XP, Windows NT, Windows ME, Windows 98, Windows 95, Windows 3.11, Windows-Longhorn, MS-DOS, PC-DOS, MXS, Mac OS X, Classic Macintosh, OS/2, Linux, Unix, NetBSD, OpenBSD, GNU Hurd, Solaris, SunOS, HP-UX, OpenVMS, Tru64 Unix, IRIX, NeXT, Rhapsody, AIX, MVS, NetWare, BeOS, AmigaOS, SCO OpenServer, SCO UnixWare, Pyramid, BSDi.

This device 100 is designed to complement any existing scanners or their future designs. The miniaturized, slow-speed, low-memory “PC Substitute” is small, lightweight and very portable. It can be connected (by AC plug and ISB cable for example) to, e.g., a flat bed scanner, without requiring or causing any modification to the scanner itself. This device 100 is totally separate from the scanner and is simply a substitute for the much larger, more powerful, more expensive and much more complicated-to-operate PC. This design, by contrast, is only programmed to support a scanner, thereby allowing operator input to become as simple as operating a copy machine.

When used with an operating system that supports USB, devices can be added and removed without powering down or reconfiguring the computer. When a new device is added or removed, the system automatically detects the change and then loads or unloads the appropriate driver.

The stand-alone scanner driving device 100 is easy to operate. Once It is connected with an optical scanner, the assembly works as easy as a simple copy machine, which does not require a computer monitor or a keyboard. As such, the operation does not require the user to be computer literate. Because the unit would require less processing capabilities compared to today's computer technology, obsolete computer components can be used to manufacture the device.

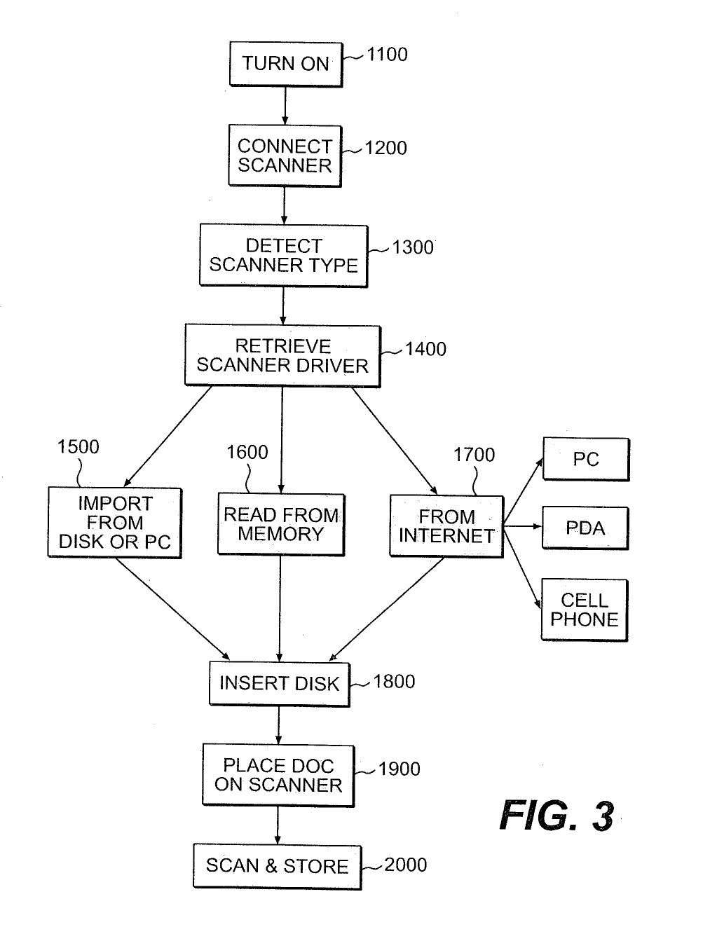

According to the flow chart in FIG. 3, the user first turns on the device 100 power (Step 1100) by pressing the button 10 until hearing the power-up chime. Once power is on, the LCD display 60 displays “Connect Scanner then Press Button” prompting the user to connect the device 10 to a scanner. The user connects the device to a scanner (step 1200) followed by pressing the button 10. The Device 10 detects the type of the scanner (step 1300) and retrieve the scanner's driver for supporting its operation with a specific operating system (step 1400). The retrieving process may be conducted via three ways: 1. Importing the scanner driver software form a storage medium received by the slot 20 or a computer (step 1500); 2. Reading form the ROM 83 a pre-stored scanner driver (step 1600); 3. downloading the scanner driver software via a computer, a PDA, a cell phone from the internet (step 1700). In one embodiment, the device 100 is ordered on-line by an end user with at least one specific scanner driver. In another embodiment, the device 100 is pre-stored with at least one popular scanner driver. In this embodiment, the input button 10 and the LCD display 60 are replaced by one touch panel on which different scanner drivers are displayed for a user to choose. Accordingly, the device 100 automatically configures a connected scanner (“connect-and-scan”). A user can connect the device 100 with a scanner and scan documents with the scanner, without worrying about setting hardware or data transmission configurations.

If the device 100 can not initialize the scanner due to the unavailability of its driver, the LCD display displays “Initialization fail”.

Optionally, the LCD display 60 displays the brand name and the model number of the scanner. The LCD display 60 then displays “Insert Disk” after the scanner driver is retrieved. The user inserts a disk or the like into the slot 20 in step 1800. The LCD display then displays “Place Doc” to prompt the user to place a to-be-scanned document in the scanner (step 1900). The LCD display displays “Push to Scan & Store” to control the device 100 to scan the document and store the information into the disk (step 2000).

There is one default graphic file type in the device 100. However, in another embodiment, the device 100 supports many different graphic file types, such as, bmp, jpg, tif, gif png and others. A variety of file formats are shown on the touch panel in the Save As dialog for the user to choose depending on how or where the file, image, or picture will be used. For example, scanning images for use on the World Wide Web is different from scanning images for printing.

With the invention, a law office could use non-professional staff to scan documents onto output media without tying up the copy machine or computers. The documents could then be transferred to computers as needed. A local store that offers pay-per-copy service could have a scanner-driving device of the invention set next to the copier that would be pay-per-scan. Individuals could scan documents/pictures and put them on a floppy disk or e-mail them directly to someone.

Benefits Enjoyed by Business Users:

Part-time clerks can copy files with no more training than using a copy machine

Doesn't tie-up a computer in the business office

Easily portable to be used in a convenient, out-of-the-way location (i.e. spare conference room or file room, etc.). However, be sure to use a scanner lock if the scanner is so equipped.

Very inexpensive to own and maintain

Eliminates unauthorized access to computer files (by eliminating the need to access a computer)

“PC Substitute” or “Converter” is small and lightweight

Storage space premium—can be easily stored in a desk drawer, file cabinet etc.

Will transfer data to any number of storage medium i.e. if floppy disk is installed, it will store the information there—if no floppy disk is detected, it will automatically send data to ISB port (or other) for external hard drive, zip drive, CD burner or any other removable storage device or to a modem for internet access

Professional offices will be able to give client, customer or patient an electronic copy of a report or document instead of (or in addition to) a traditional paper copy without having to rely on computer literate staff to prepare the copy

Portability allows traveling professional to take scanner into the field: salesman, auditor, lawyer (for discovery) etc.

Pay-per-use at Post Office, bank, retail store, mall, airport, library, college library etc. Encourages infrequent users (who don't even own a scanner) to copy, store or later transmit documents or pictures to friends or relatives, or to medical, financial, accounting and legal offices. (i.e., medical records to a new doctor, closing documents to a bank, tax documents to an accounting office or an updated contract draft to a law office.)

Benefits Enjoyed by Individuals:

Many of same benefits enjoyed by business users

Overcomes objection “Too much trouble to hook up to PC, install new software etc.”

Overcomes objection “Once connected, it takes up too much room”

Overcomes objection “Too complicated to learn how to navigate, edit or use in general”

Portable, stand alone—can routinely copy bills etc. for filing and storage on a floppy or other removable storage device (compares to convenience of stand alone CD burner or stand alone photo printer)

Benefits Enjoyed by Commercial Manufacturer:

Creates substantial number of new customers/users for their existing scanner products

Creates a new and worth-while product to sell to owners of existing scanners

Creates very attractive marketing “option”. To include unit with purchase of scanner, using manufacturer rebates, etc.

Is manufactured from obsolete computer parts i.e., slower CPU chips, much smaller hard drives, etc. thereby converting obsolete component inventory into a real winner or, better yet—allowing for the purchase of obsolete parts at real bargain basement prices to allow either exceptionally high mark-ups or very inexpensive marketing options

Creates completely new leasing/sales opportunities for pay-per-use facilities

Can be programmed to be compatible only with their brand of scanners to give their brand an additional competitive advantage

Does not make any of their scanners (or any other product) obsolete

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A portable, free-standing universal scanner driving device, comprising:
a central processing unit;
a memory;
a slot for receiving an external storage medium;
an I/O port;
means for writing data on the external storage medium;
a case; and
one and only one push-button, touch pad, or touch screen for initiating an external optical document scanner to scan a document placed in the scanner and then directly write scanned electronic data into the external storage medium by touching thereon, said push-button, touch pad, or a touch screen is integrally formed on the case.

2. The device according to claim 1, further comprising a LCD display integrally formed on the case for displaying instructions to a user.

3. The device according to claim 1, wherein the external storage medium is a Hard Disk, an Optical Disk, a tape, a CD, a Worm, a Erasable, a Zip disk, a DVD, a flash Memory Card, a Super Disk, or a network disk.

4. The device according to claim 1, further comprising a USP connector, a RS-232 connector, or a DIN connector,

5. The device according to claim 1, further comprising a power cable.

6. The device according to claim 1, further comprising another external storage medium stored with a scanner driver software for driving the scanner.

7. The device according to claim 1, further comprising a scanner driver software for driving the scanner

8. The device according to claim 7, wherein the scanner driver software is pre-stored in the memory prior to the device reaching an end user.

9. The device according to claim 7, wherein the scanner driver software is downloaded from a computer or another external storage medium stored with the scanner driver software.

10. The device according to claim 7, wherein the scanner driver software is downloaded from the internet via a computer, a PDA, or a cell phone connected with the device.

11. A system for scanning a document and storing scanned electronic data, comprising:
an optical document scanner;
a storage medium; and
a portable, free-standing universal scanner driving device comprising a central processing unit; a memory; a slot for receiving the storage medium; an I/O port; means for writing data on the storage medium; a case; and one and only one push-button, touch pad, or touch screen for initiating the optical document scanner to scan a document placed in the scanner and then directly write the scanned electronic data into the storage medium by pushing or touching thereon, said push-button, touch pad, or a touch screen is integrally formed on the case.

12. A method for scanning a document and storing scanned electronic data, comprising:
providing an optical document scanner, a storage medium, and a portable, free-standing universal scanner driving device comprising a central processing unit; a memory; a slot for receiving the external storage medium; an I/O port; means for writing data on the external storage medium; a case; and one and only one push-button, touch pad, or touch screen for initiating the optical document scanner to scan a document placed in the scanner and then directly write the scanned electronic data into the external storage medium by pushing or touching thereon, said push-button, touch pad, or a touch screen is integrally formed on the case;
connecting the driving device to the scanner;
inserting the storage medium to the slot;
pushing the push-button or touching the touch pad or the touch screen to initiate the external optical document scanner to scan a document placed in the scanner and then directly write scanned electronic data into the external storage medium.

13. The method according to claim 12, further comprising a step of retrieving a scanner driver software for driving the scanner.

14. The method according to claim 13, further comprising a step of pre-storing the scanner driver software in the memory prior to the device reaching an end user.

15. The method according to claim 13, further comprising a step of downloading the scanner driver software form a computer or another external storage medium stored with the scanner driver software.

16. The method according to claim 13, further comprising a step of downloading the scanner driver software form the internet via a computer, a PDA, or a cell phone connected with the device.
